(19) United States
(12) Patent Application Publication
(10) Pub. No.: US 2002/0188363 A1
(43) Pub. Date: Dec. 12, 2002

(54) Apparatus and method for providing entertainment media

(76) Inventor: Michael Joseph Ashy, Dallas, TX (US)

Correspondence Address: Michael Joseph Ashy, 3409 Shenandoah St., Dallas, TX, 75205, US

(21) Appl. No.: 09/877,380

(22) Filed: Jun. 8, 2001

(51) Int. Cl. G06F 13/12; G06F 13/38; G06F 17/00

(52) U.S. Cl. 700/94

(57) ABSTRACT

A unitary and/or monolithic compact jukebox including a flat panel display and a processor positioned within an exterior casing of the flat panel display. A memory device positioned within the exterior casing and being in communication with the processor may be provided, and an interface device may be provided in communication with the processor, the interface device being configured to transmit and receive data to and from the compact jukebox. The compact jukebox may be configured to store information representative of frequencies of types of media selected by users of the compact jukebox in the memory device, the stored information may then be used to determine optimal additional media selections to be added to the compact jukebox, as well as to determine targeted advertising.

### BACKGROUND OF THE INVENTION

1. Field of the Invention

The present invention generally relates to an apparatus and method for providing entertainment media. More particularly, the present invention relates to an improved jukebox and a method for providing media thereto.

2. Description of the Related Art

Conventional jukeboxes generally are configured to play media, i.e., music and/or video, from compact discs, digital video discs, video tapes, records, cassettes, and/or other common sources of entertainment media. The specific media sources, which are most often compact discs or records, are generally stored onboard the jukebox and physically managed and/or selected for playing by an automated robotic arm assembly within the jukebox. Indexed racks are generally provided within the jukebox so that the physical space within the jukebox may be configured to hold a maximum number of discs or records. Further, these indexed racks allow for the robotic arm assembly to accurately and efficiently effectuate transfer of a selected disc/record to and from a playing station.

In operation, a user generally views a listing of songs/videos available on the jukebox, which typically comprises a hard copy listing presented on the front fascia of the jukebox. The user may then deposit one or more coins and/or bills into a payment collection receptacle on the jukebox, which allows the user to select a predetermined number of songs/videos. The user may then input one or more selected songs via actuation of a sequence of buttons corresponding to the desired songs on the fascia of the jukebox. The robotic arm may then retrieve a disc having the selected song/video thereon from an indexed bin and transfer the disc to the playing station, which may take 30 to 45 seconds. The disc may be played, and upon completion, the disc may be removed from the playing station and returned to the original indexed location by the robotic arm. An electronic controller is generally implemented to control the operation of the electronic arm, receive/manage the coins and/or bills from the payment receptacle, receive and process the user selections, maintain a queue of user requests, and generally control the operational features of the jukebox.

Although conventional jukeboxes are generally effective in presenting a variety of media to users, conventional jukeboxes suffer from a plurality of disadvantages. For example, conventional jukeboxes are generally 3 to 4 feet wide and 2 to 3 feet deep. Therefore, a conventional jukebox may require 12 or more square feet of floor space. Additionally, conventional jukeboxes are limited to the songs/videos on the discs or records physically present in the jukebox. Although there may be up to 100 discs in a jukebox, generally, only one or two songs on each disc are regularly requested by users, as less popular songs are often placed on albums with hits. Therefore, 80% or more of the media space in conventional jukeboxes is seldom/never used. Further, conventional jukeboxes are difficult to update and/or customize for particular locations and/or different events at a common location, as updating the selection of media generally requires replacement of the media itself along with the accompanying media list presented to the user. Therefore, new discs must be purchased and installed into the jukebox, the controller reprogrammed, and the song list on the fascia of the jukebox reprinted for display to users. Further still, conventional jukeboxes include many moving parts, and therefore, mechanical breakdowns are common. Repair generally requires scheduling of a specialized technician, which may take several days, and therefore, the machine may be unoperational, occupying space, and not generating revenue for several days.

Therefore, there exists a need for an improved jukebox, wherein the improved jukebox occupies substantially less physical space and provides a substantial selection of popular media. Further, there is a need for a jukebox that allows for easy update and/or replacement of media therein. Further still, there is a need for an improved jukebox having minimal moving parts so that mechanical breakdowns and unoperational periods may be minimized. Additionally, there is a need for a method for providing media to jukeboxes, wherein the method does not require a specialized technician in order to update/replace media on the jukebox.

### SUMMARY OF THE INVENTION

Embodiments of the present invention generally provides a monolithic compact jukebox including a flat panel display and a processor positioned within an exterior casing of the flat panel display. A memory device positioned within the exterior casing and being in communication with the processor may be provided, and an interface device may be provided in communication with the processor, the interface device being configured to transmit and receive data to and from the compact jukebox. The compact jukebox may be configured to store information representative of frequencies of types of media selected by users of the compact jukebox in the memory device, the stored information may then be used to determine optimal additional media selections to be added to the compact jukebox, as well as to determine targeted advertising.

Embodiments of the invention further provide a compact jukebox contained within a single unitary housing, the compact jukebox including a compact video display device having an outer housing generally surrounding side and rear portions of the compact video display device. A computer processor positioned within the outer housing and being in communication with the compact video display may be provided. Further at least one memory module in communication with the computer processor and being positioned within the outer housing may also be provided for storing media selections and/or program data. The compact jukebox may further include at least one data transfer device in communication with the computer processor and being positioned within the outer housing, the at least one transfer device being configured to transfer data representative of media selections between the compact jukebox and an external device.

Therefore, embodiments of the present invention provide a substantially smaller jukebox contained within the outer housing of a unitary display device. The compact jukebox generally includes the capability to monitor user selections for use in determining both possible media selection updates as well as to determine target advertising groups. The monitoring of user selections may be stored in a memory of the compact jukebox and then transmitted to a remote location for analysis to determine appropriate updated media selections and targeted advertising media. Transmission of the stored data may be through one of several known data transmission devices included within the compact jukebox. Thus, the compact jukebox of the present invention easily replaces conventional jukeboxes with a more compact jukebox that has substantially fewer moving parts, requires less maintenance, and provides a process for easily updating the media selections of the jukebox.

### BRIEF DESCRIPTION OF THE DRAWINGS

So that the manner in which the above recited features, advantages and objects of the invention are attained and may be understood in detail, a more particular description of the invention may be had by reference to the embodiments thereof, which are illustrated in the appended drawings. It is to be noted, however, that the appended drawings illustrate only typical embodiments of this invention, and are therefore, not to be considered limiting of the scope of the invention, as the invention may admit to additional and/or other equally effective embodiments not expressly shown.

FIG. 1 illustrates an exemplary embodiment of a jukebox of the invention.

FIG. 2 illustrates and general diagram of an embodiment of the invention.

### DETAILED DESCRIPTION OF THE PREFERRED EMBODIMENT

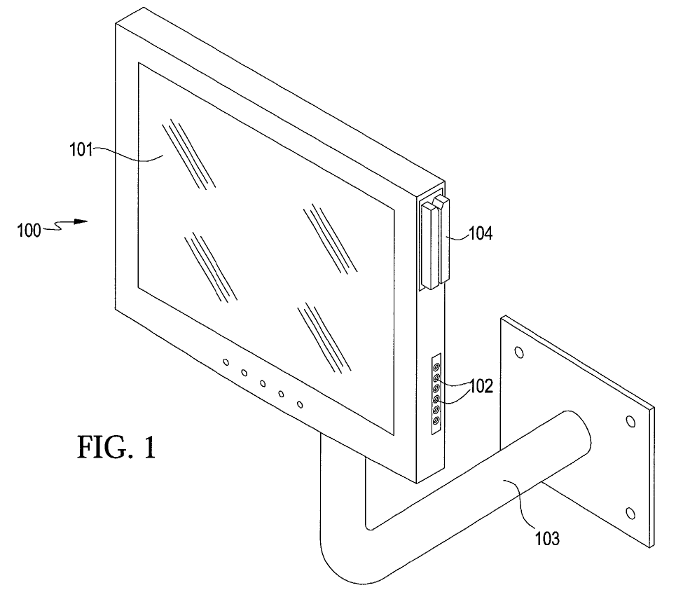

The present invention generally provides an improved compact jukebox configuration and a method for supplying media thereto. FIG. 1 illustrates an exemplary embodiment of a compact jukebox 100 of the present invention that may be used to replace conventional jukeboxes. The hardware components of jukebox 100 may generally be contained within a flat panel display 101, which may be similar to the flat panel displays sold for use with personal computers, for example. Display 101 may be used to display music and/or video selections to users, and further, to receive user selections. For example, display 101 may be a touch-screen enabled-type display, wherein the user may make selections by touching an area of the screen corresponding to the selection. Therefore, display 101 may operate to both display music/video selections to users and to receive user input. Additionally, in an embodiment where jukebox 100 is set up for video operation, display 101 may also be used to present selected video media to the user once a video selection has been received. In this configuration, display 101 may also include the ability to simultaneously present audio, for example, through either an integrated sound system, or alternatively, display 101 may include the electronic capability to interface and/or drive external audio devices.

Additionally, although the embodiments of the invention described herein are described with respect to a flat panel display, the scope of the invention is not intended to be limited thereto. For example, various types of compact display apparatuses are currently available to the public, such as, for example, reduced dimension video monitors, flat screen televisions and computer monitors, compact plasma-type display units, along with several other publicly available compact video display devices. Therefore, although the description of the various embodiments of the invention generally recite the use of a flat panel display, the invention is not in any way intended to be limited thereto, as it is contemplated that any one of the publicly available compact video display devices may be implemented in place of the flat panel display discussed herein.

Jukebox 100 may also include an adjustable mounting assembly 103 that may be used to mount jukebox 100 to a variety of objects in a variety of orientations. For example, mounting assembly 103 may be used to mount jukebox 100 to a generally vertical object, such as a wall, for example, or alternatively, to a horizontal object, such as a table or other generally horizontal surface. Therefore, jukebox 100 may essentially be positioned in any location without requiring any floor space whatsoever. Mounting assembly 103 may be configured as a conduit for electrical connections to/from jukebox 100, as mounting assembly may have a substantially hollow interior portion that may be used to communicate electrical and other connections to jukebox 100. Generally speaking, mounting assembly 103 may be configured to allow the display area of jukebox 100 to be pivoted about a horizontal axis (pivot to adjust the screen up and down), as well as a vertical axis (pivot to adjust the screen from left to right). Further, mounting assembly 103 may be configured to rotatably pivot jukebox 100 about a central mounting point through 360°, therefore allowing jukebox 100 to completely pivot about a central mounting point if desired.

As noted above, the compact jukebox of the present invention may generally contained within the outer casing of a typical flat panel display unit. Therefore, the footprint of the compact jukebox of the present invention may essentially be “eliminated,” as the compact jukebox of the present invention may not require any floor space. Thus, the compact jukebox of the present invention may easily be mounted on a wall, a table, pedestal, pole, or other surface capable of supporting the compact jukebox. A wall or table mount-type configuration may include a mounting member configured to pivotally support the compact jukebox in a position that may be easily viewed by customers. For example, a first end of a tubular mounting member may be pivotally and/or rotatably attached to the rear portion of the compact jukebox opposite the user display screen. The second end of the tubular member may be rigidly and/or pivotally/rotatably attached to a fixed object, such as a wall, table, pole, or other generally stationary device/apparatus. In this embodiment, the compact jukebox may generally be confined to the area proximate the fixed object via the mounting configuration. However, the mounting assembly may include pivotal connections that may allow a user of the compact jukebox to make adjustments to the position of the screen of the compact jukebox. For example, a user may tilt the screen of the compact jukebox in order to facilitate better viewing, i.e., up/down and left/right. Additionally, the mounting assembly may be configured to pivot in a manner that may allow the compact jukebox to pivoted and/or swung from a first location to a second location, i.e. from a first location proximate users to a second location not available to users, such as in a cabinet or behind a bar, for example.

In another embodiment of the invention, the compact jukebox of the may be suspended from an overhead support system. For example, the compact jukebox of the present invention may be supported by a plurality of cables rigidly attached to overhead fixed members. In this embodiment, the plurality of cables may include piggy-back electrical/data communication lines that may be used to supply electrical power and data communication ability to the suspended compact jukebox. Alternatively, the compact jukebox of the present invention may be supported by a tubular member configured to attach to an overhead support structure, such as a ceiling. In this configuration, the overhead tubular member may also be provided with one or more pivotal members/joints that allow the compact jukebox of the present invention to be pivotally positioned, i.e., the compact jukebox may again be rotated out of a specific area into a storage space if desired.

Regardless of the mounting configuration of the compact jukebox of the present invention, a primary novel feature of the invention is that conventional jukebox functions, along with numerous additional features, may be contained in a unit that may be 10 to 100 times smaller than conventional jukeboxes. For example, the compact jukebox of the invention may easily be contained within the outer casing of a conventional 15 inch flat panel display unit. These units, which generally measure 15 inches across the diameter of the screen and are only a few inches deep, typically occupy less than a cubic foot of airspace. Although a 15 inch flat panel display configuration is presented, the present invention is not intended to be limited to a 15 inch display, as both smaller displays, such as 12 and 13 inch, along with larger displays, such as 17, 19, 21, and 22 inch and larger displays may be implemented in the present invention. However, generally flat panel displays in the 15 to 22 inch range are preferred, as these displays offer sufficient display area for the operation of the compact jukebox, while not substantially increasing the price of the unit. As a comparison, the compact jukebox of the present invention may be contained in a 15 to 17 inch flat panel display that may occupy a volume of approximately 1 to 3 cubic feet and no floor space, while conventional jukeboxes may regularly occupy 12 to 15 square feet of floor space and 48 to 60 cubic feet or more of volume. Additionally, smaller flat panel-type displays may occupy a volume of between about 0.5 cubic feet and about 1.5 cubic feet. Therefore, the compact jukebox of the present invention may substantially reduce the volume occupied by a jukebox, and further, depending upon the mounting configuration of the compact jukebox, embodiments of the present invention may completely eliminate the floor space required by conventional jukeboxes.

Aside from the screen size and the volume occupied by the compact jukebox of the present invention, it is also contemplated that the proportion of the screen width and/or diagonal measurement to the depth of the compact jukebox is generally less than 2 to 1. Further, in one preferred embodiment, the proportion of the screen width and/or diagonal dimension to the depth of the compact jukebox is contemplated as being 3 to 1, and possibly 4 to 1. Therefore, assuming that the proportion is 3 to 1, then a compact jukebox having a diagonal display dimension of 15 inches would have a depth of only 5 inches.

Returning to the discussion of the hardware components that may be utilized by the compact jukebox of the invention, a payment device 104 may be included in compact jukebox 100 for receiving payment from users for playing media on jukebox 100. Payment device 104 may include a card reader, a card swipe device, a coin and/or bill receiving device, and/or other devices known to provide payment receipt capability in jukebox-type devices. Jukebox 100 may further include various inputs and/or outputs 102 for receiving and/or transmitting information therefrom. For example, jukebox 100 may include audio/video outputs for communicating with external audio/video devices, such as external speakers and/or video monitors, audio/video inputs for receiving media in jukebox 100, such as new/replacement audio and/or video media, a broadband communications terminal/interface for transmitting and receiving information from jukebox 100, power supply inputs, and other inputs/outputs known in the art that may be used to present media or receive media in jukebox 100.

Jukebox 100 may further include a stand-alone communications device/interface configured to communicate with other devices without using hardwired line. For example, jukebox 100 may include a radio frequency transmitter/receiver unit configured to transmit and receive radio frequency signals. In this configuration, jukebox 100 may communicate with a remote media service provider through the radio frequency transmitter/receiver unit in order to receive and/or transmit data/media therebetween. Similarly, jukebox 100 may include a cellular communications device. In this embodiment the cellular communications device may be used to transmit an receive data/media between jukebox 100 and a remote location, wherein the remote location may be a media service provider configured to supply media updates to jukebox 100.

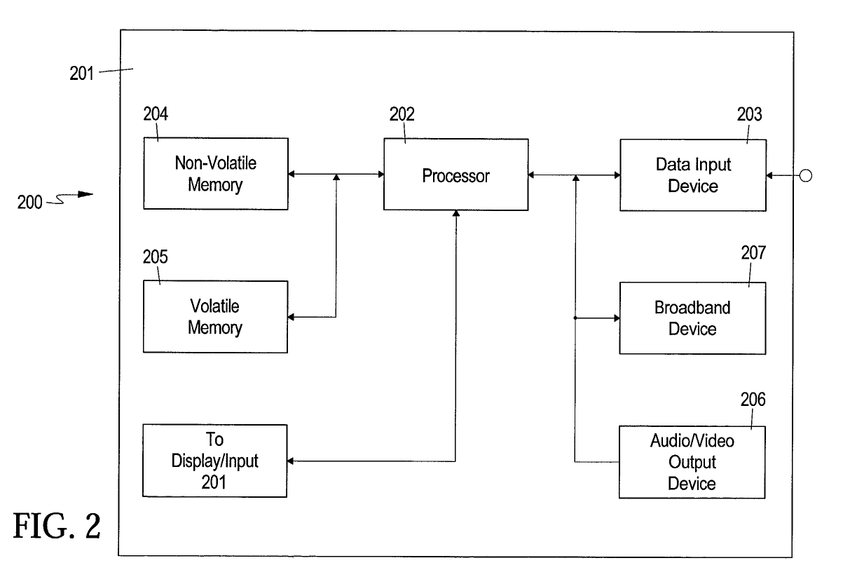

FIG. 2 illustrates an exemplary configuration of an embodiment of the compact jukebox of the present invention. Jukebox 200 may include a touch screen-type display 201 that may be used to present media selections to users, receive media selections via a touch screen configuration, and display selected media to users. The size of display 201 is contemplated as being small enough to be held in the hand of a user and large enough to be effectively used as a wall mounted display unit. Display 201 is generally in communication with a processor/controller 202, which may operate to control the operation of display 201 by receiving input therefrom and generating video images to be displayed thereon. Processor 202 may operate to regulate and/or control the operation of display 201, along with other components of jukebox 200, via execution of programs stored in a memory 204, which may be in communication with processor 202. Processor 202 may be a known computer/microprocessor capable of executing software instructions retrieved from a memory, such as, for example, processor chips manufactured by Intel® Corporation, AMD® Corporation, Texas Instruments®, and other known processor/complex semiconductor chip manufacturers. Memory 204 may be a known non-volatile computer readable-type medium, such as, for example, a hard disc drive or other known non-volatile computer readable medium. Processor 202 may also be in communication with a volatile memory 205, such as, for example, random access memory (RAM) or a FLASH-type memory, which may be used to temporarily store computer programs and data associated therewith that requires substantially faster access times than that which may be provided by nonvolatile memory 204 during operation. Processor 202 may also be in communication with one or more data input devices 203 and a broadband communication device 207. Input devices contemplated within the scope of the present invention may be computer keyboards, a computer mouse, a remote control unit, and/or other known devices for communicating a signal to a computer, audio device, and/or video device. A media output 206, such as, for example, an audio or video output, in communication with processor 202 may be used to transmit audio and/or video signals from jukebox 200 to external devices, such as external speakers and video display devices. Thus, the combination of processor 202, memories 204 and 205, and broadband communication device 207 essentially provides the compact jukebox of the present invention with general computing capabilities. As such, various computer programs may be stored on memory 204 and subsequently executed by processor 202 in order to accomplish various tasks related to the operation of the exemplary jukebox.

In another embodiment of the invention, the compact jukebox is provided with the ability to capture and store data representative of the frequency of user selections. For example, when a particular media object is selected by a user, the exemplary jukebox may be configured to record statistics representative of the users selection. These statistics may include, the type of media file selected, the particular artist related to the media file, the number of times the particular file has been selected in a predetermined period of time, and/or other statistical information that may be useful in analyzing user preferences at the particular location at which the compact jukebox is located. Additionally, the present embodiment of the invention may also include a software program that when executed by the compact jukebox's processor, is configured to transmit the statistical information stored in the compact jukebox to a remote location for analysis. This analysis may be used to determine what media files may be replaced and/or modified on the compact jukebox in order to optimize user satisfaction. For example, the software program may be configured to store the type of music played on an audio-based jukebox. Therefore, when this information is transmitted to a remote analysis location, it may be determined that additional music corresponding to the type of music most often played should be added to the compact jukebox in order to maximize user selections in that particular type of music, which will likely increase the users satisfaction and the revenue generated by the compact jukebox.

In operation, jukebox 200 may present a plurality of music and/or video selections to the user via touch screen display 201. The selections may be presented and/or organized by audio/video type (music type), artist, movies/songs, or other categorizations that the user may desire. Regardless of the organizational scheme, predetermined areas on screen 201 may be configured to correspond to particular selections, and therefore, when the user touches a specific area on the screen corresponding to a particular song/video, display 201 may operate to transmit the selection to processor 202. Processor 202 may interpret the user selection and begin retrieving the selected media file from memory 204. The retrieved media may be buffered for presentation to the user through volatile memory 205, or alternatively, directly read from memory 204 and simultaneously presented to the user. Although both methods are generally effective, embodiments of the invention generally utilize a buffered presentation method, as minute delays in access to non-volatile memory 204 may degrade the quality of the media presented. Presentation of the selected media, once retrieved by processor 202, generally includes the selected media being output from jukebox 200 via outputs 206 or through onboard output devices, such as display 201 or onboard audio devices (not shown).

If multiple selections are made by the user, then processor 202 may operate to generate and manage a queue of media to be played. This queue may be represented by a data structure set up in either memory 204 or volatile memory 205. Regardless of the configuration, processor 202 may receive multiple media selections from multiple users, queue the selections in accordance with a predetermined algorithm, and sequentially present the media selections in accordance with the predetermined algorithm.

In another embodiment of the invention, display 201 may further be configured to display advertising information to users. For example, display 201 may be configured to cooperatively present advertising banners and/or general advertising information along with media selections to users during the media selection process. Additionally, once the media selection process is completed by the user, display 201 may be configured to display a full screen of advertising banners or like images to users, thus maximizing the presentation time to the user, assuming that the compact jukebox is operating in an audio mode and not a video presentation mode. In this configuration, the compact jukebox may be configured with a timing device, which may be used to determine when a predetermined amount of time has passed since a user has made a media selection. Thus, once the predetermined amount of time has passed, then the display of the compact jukebox of the invention may be transformed from displaying user selections to an advertising mode wherein a substantial portion of the display is then used to display advertising information to users. In this configuration, once a user touches the screen, or otherwise interacts with the compact jukebox, then the compact jukebox may be configured to return to a media operation mode wherein media selections are presented to the user, possibly in conjunction with advertising information. Each of these functions may be managed through a software program stored in an onboard memory device, wherein the operations of the software program may be executed by an onboard computer processor.

In the embodiments of the invention capable of displaying advertising information to users, compact jukebox may further be configured to record and store information received by the compact jukebox for use in determining/targeting potential advertising markets. For example, as noted above, the compact jukebox of the invention may be configured to store information related to the types and frequency of media selections made on the compact jukebox. This information may be transmitted to a remote location for analysis in order to determine what an average/estimated demographic of users of the compact jukebox, i.e. the media selections made on a specific compact jukebox may be used to target a specific demographic of customers. This information may then be used to determine what forms/types of advertising may be most effective on the compact jukebox given the estimated demographic. Thus, the compact jukebox of the present invention offers advertisers the ability to select a targeted market for presentation of advertising information, which operates to maximize the effectiveness of the advertising expenditure.

A payment device 208, such as payment device 104 illustrated in FIG. 1, may be implemented into jukebox 200. Payment device 208 may be, for example, a card reader device. The card reader device may be used to charge users for media selections via credit card charges, debit card charges, prepaid media card charges, and/or other known charge methods. As such, users may simply swipe a card through payment device 208, make media selections, and then processor 202 in conjunction with payment device 208 may charge the appropriate amount to the card. If necessary, processor 202 may be in communication with a modem or other communications device necessary to verify charge-type transactions, as is known in the art.

Alternatively, embodiments of the present invention may utilize a user account-type system for payment. For example, jukebox 200 may be configured to receive a single payment, either directly through payment device 208 or through an alternative source. Upon making a single payment, processor 202 may generate a personal identification number (PIN) for the user through a PIN number generation software program stored in a memory 204, which may then be displayed to the user through display 201. Jukebox 200 may be configured to generate and store a user account in memory 204, wherein the user account may contain information pertaining how much of the initial payment has been used to date. Thus, a user may make a single charge through payment device 208, and thereafter, for example, the user may simply enter the PIN number into the touch screen display 201 and make media selections, which may then be deducted from the user's account, i.e., the users essentially virtual account, through a memory write operation conducted under the instruction of processor 202, for example.

Therefore, in sum, embodiments of the present invention allow users to set up an account having a user name and/or password/PIN associated therewith. The account setup process may generally include setting up the user name and/or PIN number and funding the account. Thereafter, the user may simply enter either the user name and/or PIN number information into the display 201 in order to make media selections. Any selections made may then be debited to the particular users account via a software program executed by the processor and configured to manage various user account information. Once the user's account is depleted, then the user may be notified to replenish funds in the account in order to continue making selections on the compact jukebox.

Alternative sources of payment may be, for example, cellular-based payment systems. For example, jukebox 200 may be configured with a communications device capable of receiving cellular communications. A user may then establish communication with jukebox 200, or another device configured to cooperatively operate with jukebox 200, via a cellular call from the users cellular phone. Jukebox 200 may either obtain charge information from the cellular call, or alternatively charge the cellular service provider for the users media selections, which may then be billed to the user via their monthly cellular bill. Thus, a user would not be required to utilize the payment device 208 or to carry charge cards compatible with jukebox 200. Alternatively, the user may utilize a cellular phone to transmit credit card and/or charge related information to the compact jukebox in order to make payment to the compact jukebox.

Another primary feature of the present invention is the versatility offered in the media updating process. Media updating, as will be discussed herein, generally refers to the process of removing, replacing, modifying, and/or updating media available for users to select on the compact jukebox of the invention. For example, one embodiment of the invention provides for use of a compact disc changer configuration as a media source. In this embodiment, a compact disc changer may be incorporated into the compact jukebox and used for the media source. The changer, for example, may be configured to hold 20 or more compact discs, depending upon size considerations. However, the present embodiments contemplates that the individual discs in the changer are not traditional “albums” published by a single artist. Rather, each disc may be specifically formatted to contain specific media, i.e., each disc may contain the most popular songs from several albums. Therefore, although the compact jukebox of the present embodiment may hold substantially fewer compact discs than conventional compact disc based jukeboxes, the availability of popular media selections may be substantially greater as a result of the formatting of the individual discs. Inasmuch as a typical compact disc may hold 20 or more typical songs, a 20-disc compact disc changer may hold 400 or more individual songs.

In an embodiment where a compact disc changer is utilized as the media source, the process of updating the media may simply entail replacing the compact discs in the changer with newly formatted discs having updated media thereon. This process may generally be conducted an ordinary person, as no special skills are generally required to change compact discs in a disc changer. However, embodiments of the invention provide a process for determining the content of the new discs that is also an improvement over conventional devices. For example, an embodiment of the invention may provide the compact jukebox with the ability to store the types of media most requested by users in memory. This information may then be periodically transmitted from the compact jukebox to a remote location for processing, through, for example, an Internet connection, a telephone dialup connection, a broadband connection, a cellular connection, or other communications means that may be provided in the compact jukebox of the invention. The information may be analyzed for frequency of certain types of media, artist frequency, and/or other characteristics. This analysis may then be used to determined what types of updated media may be placed on the updated compact discs in order to maximize user satisfaction. Updated discs may then be generated and sent to the location of the compact jukebox, via mail or commercial courier, for example, where the discs may be inserted into the changer. Therefore, the compact disc changer configuration of the invention allows for a variety of media selections and for a simplistic process for updating the media selection.

In another embodiment of the invention, a single compact disc media reader may be used. In this configuration, the updating process may be similar to the compact disc changer configuration. However, in embodiments utilizing a single disc media reader, the media reader is generally not the primary source of media to be played by the compact jukebox. Rather, the single compact disc media reader may be used to read media information into an onboard non-volatile memory of the compact jukebox. This non-volatile memory, which may be a hard disk drive, may then be used as the primary media source of the compact jukebox, and the single compact disc media reader may be used to modify, update, and/or replace media selections stored in the non-volatile memory.

In the single compact disc media reader configuration, for example, the electronic components of the compact jukebox, i.e., the processor and an associated non-volatile memory, may again be used to track frequency of specific types of music, artists, and/or user selections that are not currently available on the compact jukebox. This information may then be periodically transmitted to a media service provider, where an updated compact disc may be generated based upon the frequency information generated by the compact jukebox. The updated compact disc may then be forwarded to the location of the compact jukebox, where the disc may be inserted into the compact jukebox. The media on the disc may then be transferred into the non-volatile memory onboard the compact jukebox. Therefore, the compact disc with the updated media thereon may simply be used to update the media already present on the compact jukebox with media calculated to meet user preferences. The onboard processor may then determine what media currently residing in the jukebox's non-volatile memory has been requested the least, and if necessary, purge this media therefrom. Additionally, the single disk reader may also be used to write data or information to a compact disc in the disc reader device, if desired. This data/information, for example, may again be representative of the frequency of the selection of particular media items offered by the compact jukebox of the present invention. Thus, a disc may be inserted into the single disc reader, the frequency information stored thereon, and then the disc may be transported to a third party for analysis of the information on the disc.

Another advantage that may be provided by the single compact disc configuration is that users may manually update the media of the compact jukebox. For example, a user may insert a compact disc into the single disc media reader. The disc may be initially scanned by the disc reader and a list of media contained on the disc may be presented to the user on a display of the compact jukebox. The user may then use the input capability of the compact jukebox to select a particular media item on the disc for transfer to the compact jukebox. The media item selected may be transferred into a non-volatile memory onboard the compact jukebox, and thereafter, be available for selection by user thereof.

In another embodiment of the invention, a broadband communications device within the compact jukebox may be used to update the media in the non-volatile memory of the compact jukebox. For example, in similar fashion to previous embodiments, the processor and memory of the compact jukebox may be configured to monitor and store data representative of the frequency of selection of certain types of media offered by the compact jukebox. This data/information may be stored in a nonvolatile memory of the compact jukebox and periodically transmitted to a media service provider via the broadband communications device. The media service provider may, for example, analyze the frequency characteristics of the media selections on the compact jukebox in order to determine additional/replacement media for the compact jukebox. This additional/replacement media may then be transmitted to the compact jukebox and received by the broadband communications device. The processor may then store the additional/replacement media in the non-volatile memory. Additionally, the processor may purge media having a low frequency of selection from the non-volatile memory in order to free up storage space for additional media calculated to be more appealing to users.

In another embodiment of the invention the broadband communications device may be replaced by a telecommunications modem, similar to those commonly utilized by personal computers. Operationally, the modem may send and receive information in the same manner as the broadband communications device, although the modem will generally transmit information at a slower data rate. Despite the slower data rate, modem technology may be preferred in some situations, as the cost impact of maintaining a broadband communication link for use by the compact jukebox may be prohibitive. If a broadband communications link is already available, for example, when the compact jukebox is implemented in a location that already has broadband service, then utilization of the broadband communication device is likely a viable option. In other situations, the implementation of modem technology is generally preferred, as this technology only requires access to a telephone line. The media service provider may provide a toll free access number for the compact jukebox, and therefore, the cost to the owner of the location where the compact jukebox is placed may be minimized. Additionally, the media update process may be programmed to take place at predetermined times specifically calculated not to interfere with the normal operation of the telephone line, i.e., in the very early morning hours when the telephone line is rarely utilized.

In either of the embodiments utilizing the broadband connection and/or the modem communications device, the compact jukebox of the present invention may embody a web enabled compact jukebox. As such, the compact jukebox of the present invention may be configured to access the Internet and/or World Wide Web and display information obtained therefrom to users. In this configuration the compact jukebox may be configured to access various audio and video web sites, download media files therefrom, and then present these media files to the users. This configuration allows for the creation of a web-based subscription service configured to provide media selections to compact jukeboxes positioned around the world, as each of the compact jukeboxes may be in communication with the Internet and the subscription web site.

In another embodiment of the invention, a complete non-volatile memory swap may be used to update and/or replace the media in the compact jukebox. In this embodiment, the non-volatile memory may be configured to be removable from the compact jukebox. Therefore, the non-volatile memory may be completely removed from the compact jukebox and replaced with another non-volatile memory. In this configuration, a media service provider may update the media on the compact jukebox by sending a replacement non-volatile memory unit to the location of the compact jukebox. The replacement non-volatile memory may be installed by simply removing the old non-volatile memory and replacing it with the new one. For example, once the media service provider determines what portions of the compact jukebox media should be revised, updated, and/or replaced, then the media service provider may generate an updated or new non-volatile memory unit, which may be, for example, a removable hard disk drive. The updated hard disk drive may be sent to the compact jukebox location via commercial carrier, for example. Once received at the compact jukebox location, the new hard disk drive may be inserted into the compact jukebox in replacement for the old hard disk drive, using, for example, known interchangeable hard disk drive technology. The old hard disk drive may then be shipped back to the media service provider where it may be reprogrammed and sent out to another location as an update to another hard disk drive.

In yet another embodiment of the invention, another form of a complete non-volatile memory exchange operation may be used to update and/or replace the media in the compact jukebox. In this embodiment, the non-volatile memory may again be configured to be removable from the compact jukebox. For example, the non-volatile memory may be a FLASH-type memory, which is generally known to be a high-speed non-volatile memory module that is generally preferred in configurations where a memory device may be transferred or otherwise separated from an accompanying processor. FLASH memory is known, for example, to be used in personal digital assistants, wherein the FLASH memory, which may be in the form of a memory stick, may be removed from one personal digital assistant and placed in another. In these configurations, the data stored in the FLASH memory, which may be several megabytes of data, may be instantly available to the second personal digital assistant. Furthermore, FLASH memory may be remotely programmed and then installed into a device, thus allowing the device instant access to the programmed information.

Therefore, in the FLASH memory embodiment, the FLASH memory may be completely removed from the compact jukebox and replaced with another FLASH memory module. In this configuration, a media service provider may update the media on the compact jukebox by simply sending a replacement FLASH memory module to the location of the compact jukebox. The replacement FLASH memory may be installed by simply removing the old FLASH memory module and replacing it with the new one. For example, once the media service provider determines what portions of the compact jukebox media should be revised, updated, and/or replaced, then the media service provider may generate an updated or new FLASH memory module The updated FLASH memory module may be sent to the compact jukebox location via commercial carrier, for example. Once received at the compact jukebox location, the new FLASH memory module may be inserted into the compact jukebox in replacement for the old hard disk drive, using, for example, known interchangeable FLASH memory technology. The old FLASH memory module may then be shipped back to the media service provider where it may be reprogrammed and sent out to another location as an update to another compact jukebox.

In another embodiment of the invention, the processor and memory devices of the compact jukebox may be configured not only to store data representative of the frequency of media selections, but also data representative of the number of times specific media selections have been selected by users. This data may then be transmitted to the media service provider through, for example, the above noted broadband connection, a modem connection, or another known form of communication. Upon receipt of the data representing the frequency of users selections of specific media selections, the media service provider may determine appropriate royalties that may be paid to artists or recording organizations. Therefore, although the need using each artist's compact disc may be eliminated, the artist's royalty is unaffected by the present invention.

In yet another embodiment of the present invention, the compact jukebox of the present invention may be embodied in a large wall mounted-type flat panel screen, for example. Media selections may then be presented to a large quantity of users in a single area, such as, for example, in a pub or other social-type environment. In this configuration users may interact with the large screen through remote controls, remotely position keyboards and/or a computer mouse, as well as through other known input devices. The jukebox of this embodiment may be used to service a large crowd, and therefore, the logic supporting the jukebox of this embodiment may be configured to receive and process inputs from several sources, prioritize these inputs, and present media selections to the users in accordance with the prioritization scheme.

While the foregoing is directed to exemplary embodiments of the present invention, other and further embodiments of the invention may be devised without departing from the basic scope thereof, wherein the scope thereof is determined by metes and bounds of the claims that follow.

1. A monolithic compact jukebox, the monolithic compact jukebox comprising:
a flat panel display;
a processor positioned within an exterior casing of the flat panel display;
a memory device positioned within the exterior casing and being in communication with the processor; and
an interface device in communication with the processor, the interface device being configured to transmit and receive data to and from the compact jukebox,
wherein the compact jukebox is configured to store information representative of frequencies of types of media selected by users of the compact jukebox in the memory device, the stored information being used to determine optimal additional media to be added to the compact jukebox.

2. The monolithic compact jukebox of claim 1, wherein the flat panel display has a diagonal screen measurement of between about 15 inches and about 22 inches and occupies a volume of less than about 3 cubic feet.

3. The monolithic compact jukebox of claim 2, wherein the flat panel display occupies a volume of less than about 2 cubic feet.

4. The monolithic compact jukebox of claim 1, wherein the flat panel display is mounted to an object positioned above a floor and occupies no physical floor space.

5. The improved monolithic compact jukebox of claim 1, wherein the interface device further comprises at least one of a radio frequency device, a cellular communications device, a telephonic data transmission modem, a broadband communications device, a single compact disc reader device, a multi-disc compact disc changer device, a selectively detachable hard disk drive device, and a FLASH memory module.

6. The monolithic compact jukebox of claim 1, wherein the flat panel display is mounted to at least one of a floor, a wall, a ceiling, a table, a generally horizontal surface, and a generally vertical surface

7. The monolithic compact jukebox of claim 1, wherein the memory device further comprises at least one of a random access memory module, a hard disk drive device, and a flash memory module.

8. The monolithic compact jukebox of claim 1, wherein the processor is configured to monitor media selections on the compact jukebox, generate frequency data representative of the media selections, and store the frequency data in a memory.

9. The monolithic compact jukebox of claim 1, wherein the interface device is configured to transfer media related data between the compact jukebox and an external device.

10. The monolithic compact jukebox of claim 1, wherein at least one of a width and a diagonal measurement of the flat panel display is 2 times a depth measurement.

11. The monolithic compact jukebox of claim 1, wherein at least one of a width and a diagonal measurement of the flat panel display is 3 times a depth measurement.

12. A compact jukebox contained within a single unitary housing, the compact jukebox comprising:
a compact video display device having an outer housing generally surrounding side and rear portions of the compact video display device;
a computer processor positioned within the outer housing and being in communication with the compact video display;
at least one memory module in communication with the computer processor and being positioned within the outer housing; and
at least one data transfer device in communication with the computer processor and being positioned within the outer housing, the at least one transfer device being configured to transfer data representative of media selections between the compact jukebox and an external device.

13. The compact jukebox of claim 11, wherein the compact video display device further comprises at least one of a flat panel display device, a compact flat screen plasma display device, a compact monitor device, and a compact television-type display device.

14. The compact jukebox of claim 11, wherein the compact video display device occupies a volume of less than about 3 cubic feet.

15. The compact jukebox of claim 11, wherein the compact video display device occupies a volume of between about 0.5 cubic feet and about 1.5 cubic feet.

16. The compact jukebox of claim 11, wherein the at least one memory module further comprises at least one of a hard disk drive-type memory, a random access-type memory, and a flash-type memory.

17. The compact jukebox of claim 11, wherein the at least one data transfer device further comprises at least one of a broadband communications module, a telephonic modem module, a radio frequency communications module, and a cellular communications module.

18. The compact jukebox of claim 11, wherein the at least one data transfer device further comprises at least one of an interchangeable hard disk drive, an interchangeable random access memory module, a single compact disc drive, a multiple compact disc changer and drive device, and an interchangeable flash memory module.

19. The compact jukebox of claim 11, further comprising a mounting assembly configured to mount the compact jukebox to a location above a floor and utilizing zero floor space on the floor.

20. The compact jukebox of claim 11, wherein the mounting assembly further comprises a tubular mounting member pivotally attached to a rear portion of the compact jukebox at a first mounting end via a first mounting bracket and rigidly attached to a fixed member at a second end via a second mounting member such that the position of the compact jukebox may be adjusted relative to the fixed member.

21. The compact jukebox of claim 20, wherein the tubular mounting member includes a substantially hollow interior portion, the substantially hollow interior portion being used to communicate at least one of an electrical and a communication line to the compact jukebox from the fixed member.

22. The compact jukebox of claim 11, wherein the computer processor is configured execute a computer program that operates to monitor and store media selections on the compact jukebox.

23. The compact jukebox of claim 22, wherein the computer program is further configured to generate frequency data representative of the media selections and store the frequency data in a memory.

24. The compact jukebox of claim 11, wherein the processor is configured to execute a program stored in a memory, the program being configured to display media selections, receive a media selection from a user, store data representative of the media selection in a memory for future analysis, present the media selection to the user, and simultaneously present targeted advertising information to the user.
